(19) United States
(12) Patent Application Publication
(10) Pub. No.: US 2009/0165261 A1
(43) Pub. Date: Jul. 2, 2009

(54) Clip for a Writing Implement

(75) Inventors: Kazuhiko Furukawa, Kanagawa (JP); Yusuke Nakamura, Kanagawa (JP); Kengo Nagaoka, Kanagawa (JP)

Correspondence Address: FOLEY AND LARDNER LLP;SUITE 500, 3000 K STREET NW, WASHINGTON, DC, 20007, US

(73) Assignee: MITSUBISHI PENCIL CO., LTD., Tokyo (JP)

(21) Appl. No.: 12/084,771

(22) PCT Filed: Oct. 27, 2006
(86) PCT No.: PCT/JP2006/322032

§ 371 Date: May 9, 2008

(30) Foreign Application Priority Data
Nov. 10, 2005 (JP) 2005-326516

(51) Int. Cl. B43K 25/02

(52) U.S. Cl. 24/11 R

(57) ABSTRACT

A ballpoint pen body 1 has a convex portion 4 integrally formed on the outer surface 1a thereof, and a pair of shaft bodies 4a are formed on the convex portion 4. Receiving holes 5e are formed in a clip body 5 between the ball portion 5a and the operation portion 5b. With the shaft bodies 4a being received in the receiving holes 5e, the clip body 5 and the ballpoint pen body 1 are swingably coupled to each other. The receiving holes 5e are sized to be larger than the shaft bodies 4a, and the clip body 5 is allowed to move relative to the ballpoint pen body 1 being coupled to the ballpoint pen body 1. A leaf spring 6 is provided to urge the clip body 5 toward the ballpoint pen body 1.

### TECHNICAL FIELD

The present invention relates to a clip for a writing implement.

### BACKGROUND ART

A clip for a writing implement has heretofore been known, wherein the clip includes a clip body, wherein a receiving hole is formed in the clip body and a shaft body is formed on the outer surfaces of the writing implement body, wherein the shaft body is received in the receiving hole to thereby swingably couple the clip body and the writing implement body to each other, and wherein the receiving hole is sized substantially identical to the shaft body.

A clip for a writing implement has also been known, wherein the clip includes a clip body, wherein a shaft body is attached to the clip body and a receiving hole is formed in the internal space of the writing implement body, wherein the shaft body is swingably received in the receiving hole to thereby couple the clip body and the writing implement body to each other, wherein the receiving hole is sized to be larger than the shaft body so that the clip body is able to move relative to the writing implement body while being coupled thereto, and wherein the clip includes a spring for urging the clip body toward the initial position (see JP-A-2004-190699).

With the former clip for the writing implement, however, limitation is imposed on the thickness of an article that can be gripped, i.e., a problem resides in that it is difficult to reliably grip an article having a large thickness.

With the latter clip for the writing implement, on the other hand, the clip body can move in a direction in which it separates away from the writing implement body making it possible to reliably grip an article having a large thickness. In this clip, the receiving hole is provided in the internal space of the writing implement body, and thus the receiving hole and the shaft body are coupled to each other in the internal space. Usually, however, the internal space is so small that it is difficult to couple the clip body and the writing implement body to each other in the small internal space or, in other words, it is difficult to assemble the clip with the writing implement. To begin with, it is difficult to accommodate the receiving hole and the shaft body in the small internal space. It is not realistic to expand the internal space simply for the purpose of accommodating the receiving hole and the shaft body.

### DISCLOSURE OF THE INVENTION

In order to solve the above problem, a first invention is concerned with clip for a writing implement, wherein the clip comprises a clip body, wherein one of a clip side-coupling portion formed on the clip body and an implement side-coupling portion formed on the outer surface of the body or cap of the writing implement, is constituted by a shaft body and the other is constituted by a receiving hole, wherein the shaft body is received in the receiving hole so as to swingably couple the clip body and the body or cap of the writing implement to each other, characterized in that the receiving hole is sized to be larger than the shaft body so that the clip body is able to move relative to the body or cap of the writing implement while being coupled to the body or cap of the writing implement and that the movement of the clip body relative to the body or cap of the writing implement is limited by abutment of the shaft body against a circumferential edge of the receiving hole, and that the clip comprises a spring for urging the clip body toward the body or cap of the writing implement.

A second invention is concerned with the first invention, wherein an operation portion is formed at a rear end of the clip body, wherein the spring is constituted by a leaf spring, and wherein an end of the leaf spring is attached to the implement side-coupling portion, or to the body or cap of the writing implement rearward of the implement side-coupling portion, and the other end of the leaf spring is attached to the clip body forward of the clip side-coupling portion.

A third invention is concerned with the second invention, wherein a dented groove opened facing the clip body is formed in the implement side-coupling portion so that the leaf spring is able to be positioned in the dented groove.

A fourth invention is concerned with the first invention, wherein the receiving hole is so sized that a maximum moving amount of the clip body relative to the body or cap of the writing implement is at least 0.2 times of the diameter of the shaft body.

A fifth invention is concerned with the fourth invention, wherein the receiving hole is sized so that a maximum moving amount of the clip body relative to the body or cap of the writing implement is 0.5 times to 2 times of the diameter of the shaft body.

In this specification, the tip side of the writing implement body or the open end side of the cap is considered as a front side, and the terminal side of the writing implement body or the closed end side of the cap is considered as a rear side.

According to the present invention, the clip can be easily assembled with the writing implement yet maintaining the action for holding an article having a large thickness.

### BRIEF DESCRIPTION OF THE DRAWINGS

FIG. 1A is a plan view of a whole ballpoint pen;

FIG. 1B is a side view of the whole ballpoint pen;

FIG. 2A is a side view of a clip;

FIG. 2B is a longitudinal sectional view of the clip;

FIG. 2C is a transverse sectional view of the clip along the line IIC-IIC;

FIGS. 3A, 3B, 4A and 4B are side views of the clip for illustrating an embodiment of the present invention;

FIG. 5 is a view showing a receiving hole; and

FIGS. 6A to 6L are views showing other embodiments of the receiving hole.

### BEST MODE FOR CARRYING OUT THE INVENTION

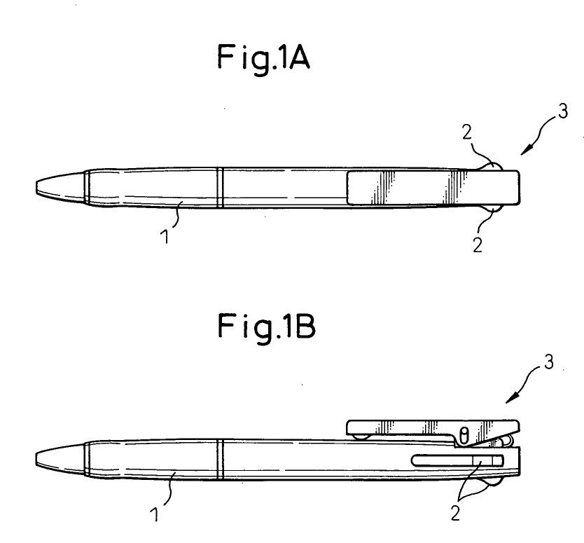

FIGS. 1A and 1B illustrate a case where the present invention is applied to the body or cylinder of the writing implement. However, the present invention can be also applied to the cap of the writing implement.

Referring to FIGS. 1A and 1B, reference numeral 1 denotes a body of a multi-color ballpoint pen housing ink-container pipes of a plurality of colors, and 2 denotes a plurality of knock members provided on the rear side of the ballpoint pen body 1. When the nock member 2 is depressed by a user, a pen point of a corresponding ink-container pipe protrudes from the front end of the ballpoint pen body 1 so as to be used. The ballpoint pen body 1 is made from, for example, a synthetic resin.

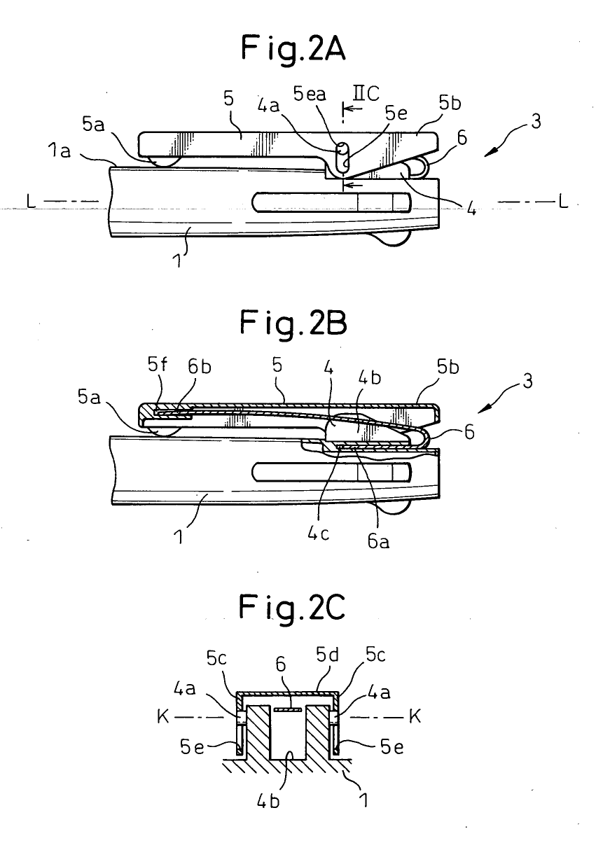

A clip 3 is arranged on the rear side of the ballpoint pen body 1 adjacent to the knock members 2. As closely illustrated in FIGS. 2A to 2C, a convex portion 4 is formed on the outer surface 1a of the ballpoint pen body 1 integrally therewith. The convex portion 4 has a pair of shaft bodies 4a formed on both side surfaces thereof, and a dented groove 4b extending between the pair of shaft bodies 4a in the longitudinal axial direction and is opened facing a clip body 5. In FIG. 2A, L-L represents the center axis of the ballpoint pen body 1 and, in FIG. 2C, K-K represents the center axis of the shaft bodies 4a.

The clip 3 comprises the clip body 5 made of, for example, a synthetic resin. A ball portion 5a is formed at the front end of the clip body 5 integrally therewith and operation portion 5b is formed at the rear end thereof integrally therewith. As will be learned, particularly, from FIG. 2C, the clip body 5 is provided with a pair of side walls 5c between the ball portion 5a and the operation portion 5b, as well as a top wall 5d connecting the side walls 5c. Receiving holes 5e are formed in the side walls 5c.

The clip body 5 is sized to house the convex portion 4 in the internal space thereof defined by the side walls 5c and the top wall 5d. Upon covering the convex portion 4 with the clip body 5 while having the pair of shaft bodies 4a received in the receiving holes 5e, the clip body 5 and the ballpoint pen body 1 are swingably coupled to each other.

It is allowable to form the receiving holes in the ballpoint pen body 1 and to form the shaft bodies on the clip body 5, as a matter of course. It is further allowable to form the receiving holes 5e in the side walls 5c around the rear end of the clip body 5 in a manner that the operation portion 5b is not formed. Generally speaking, therefore, a clip side-coupling portion is formed on the clip body, a implement side-coupling portion is formed on the body or cap of the writing implement, one of them is constituted by the shaft bodies and the other one is constituted by the receiving holes, and the shaft bodies are swingably received in the receiving holes so as to couple the clip body and the body or cap of the writing implement to each other.

As shown in FIG. 2A, in the embodiment of the present invention, the receiving holes 5e are sized to be larger than the shaft bodies 4a and have an elliptic shape. As a result, the clip body 5 is allowed to move relative to the ballpoint pen body 1 while the shaft bodies 4a being received in the receiving holes 5e, i.e., while the clip body 5 being coupled to the ballpoint pen body 1. In the embodiment of the present invention, the receiving holes 5e are formed to have a longitudinal axis substantially perpendicular to the center axis L-L of the ball-point pen body 1 (see FIG. 2A).

The clip 3 further comprises a spring 6 of, for example, metal. In the embodiment of the present invention, the spring 6 is constituted by a U-shaped single leaf spring opening facing the front side. The rear end 6a of the leaf spring 6 is forcibly inserted and fixed in an insertion hole 4c formed in the convex portion 4, and the front end 6b of the leaf spring 6 is forcibly inserted and fixed in an insertion hole 5f formed in the clip body 5 around the ball portion 5a.

The clip body 5 is urged by the leaf spring 6 toward the ballpoint pen body 1. In other words, in the embodiment of the present invention as shown in FIGS. 2A to 2C, the clip body 5 is urged by the leaf spring 6 so that the ball portion 5a abuts against the ballpoint pen body 1 and that the shaft bodies 4a abut against the top edges 5ea of the receiving holes 5e. Note that, in a natural state where the clip 3 is holding no article and no external force is acting on the clip 3, the ball portion 5a does not have to abut against the ballpoint pen body 1.

In the embodiment of the present invention as described above, the convex portion 4 is formed on the outer surface 1a of the ballpoint pen body 1, and the whole clip 3 inclusive of the leaf spring 6 is positioned on the outside of the ballpoint pen body 1. As a result, the ballpoint pen body 1 and the clip body 5 can be easily coupled to each other. Further, the internal space of the ballpoint pen body 1 does not have to be expanded for the clip 3 only.

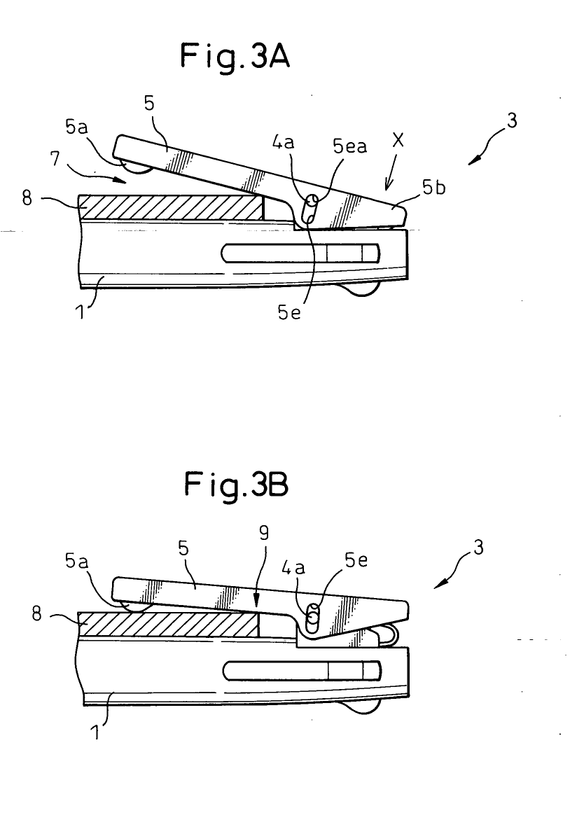

When an article such as a document or clothing is to be gripped and held by the clip 3, the operation portion 5b is depressed by the user toward the ballpoint pen body 1 as indicated by an arrow X in FIG. 3A. As a result, the clip body 5 swings about the center axis K-K of the shaft bodies 4a (FIG. 2C) while the shaft bodies 4a abut against the top edges 5ea of the receiving holes 5e, the ball portion 5a separates away from the ballpoint pen body 1, and therefore, a space 7 is formed between the ball portion 5a and the ballpoint pen body 1. An article 8 is then inserted in the space 7. In the example shown in FIG. 3A, the article 8 is inserted so as to abut against the clip body 5. Then, after the force applied to the operation portion 5b is removed, the clip body 5 swings about a portion 9 where the article 8 and the clip body 5 are in contact as shown in FIG. 3B. At this moment, the shaft bodies 4a separate away from the top edges 5ea of the receiving holes 5e and move in the receiving holes 5e. Thereafter, as the ball portion 5a abuts against the article 8, the clip body 5 no longer swings and the shaft bodies 4a no longer move in the receiving holes 5e, i.e., the article 8 is held by the clip 3 in a state where the clip body 5 is separated away from the ballpoint pen body 1. Accordingly, the article 8 having a large thickness can be reliably held as compared to when the clip body 5 is not allowed to move relative to the ballpoint pen body 1.

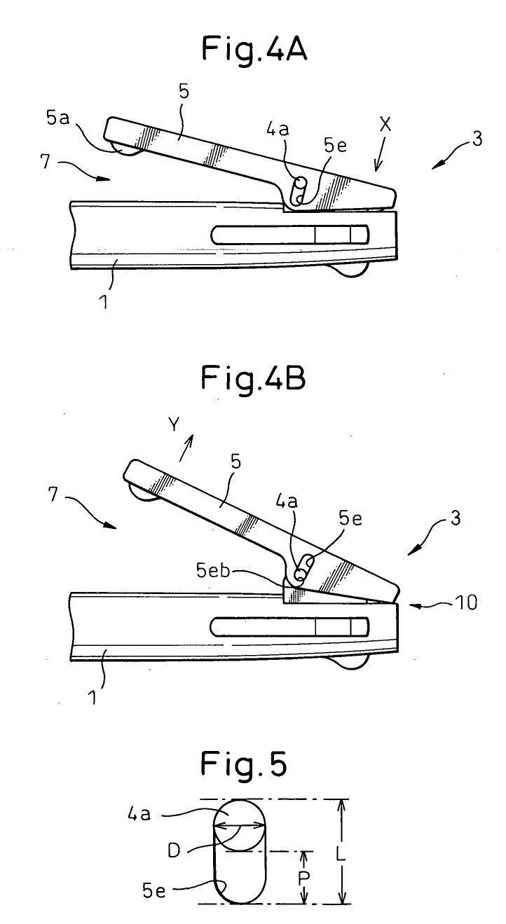

Alternatively, as shown in FIG. 4A, after the operation portion 5b is depressed, the user may exert a force as indicated by an arrow Y in FIG. 4B to the clip body 5 forward of the receiving holes 5e. In this case, the clip body 5 swings about a portion 10 where the clip body 5 and the ballpoint pen body 1 are in contact, and the shaft bodies 4a separate away from the top edges 5ea of the receiving holes 5e and move in the receiving holes 5e. In other words, the clip body 5 moves so as to separate away from the ballpoint pen body 1. As a result, the space 7 can be more increased than when the clip body 5 cannot be moved relative to the ballpoint pen body 1, and an article 8 having a large thickness can be reliably held.

Not only in the case FIGS. 3A and 3B but also in the case of FIGS. 4A and 4B, as the shaft bodies 4a abut against the bottom edges 5eb of the receiving holes 5e, limitation is posed on the movement of the clip body 5 in a direction in which it separates away from the ballpoint pen body 1. When the article 8 is removed from the clip 3, on the other hand, the clip body 5 moves to approach the ballpoint pen body 1 and, at this time, the shaft bodies 4a move in the receiving holes 5e. Then, as the ball portion 5a abuts against the ballpoint pen body 1 and the shaft bodies 4a abut against the top edges Sea of the receiving holes 5e, the clip body 5 returns back to the initial position (FIGS. 2A to 2C).

In this way, the movement of the shaft bodies 4a or clip body 5 relative to the ballpoint pen body 1 is limited by the circumferential edge of the receiving holes 5e. As described above, the receiving holes 5e have longitudinal axes substantially perpendicular to the center axis L-L of the ballpoint pen body 1. In this case, the longitudinal length L of the receiving holes 5e from the top edge Sea to the bottom edge 5eb thereof defines a maximum amount P of movement of the clip body 5 relative to the ballpoint pen body 1 in the radial direction of the ballpoint pen body 1. In the embodiment of the present invention as shown in FIG. 5, the longitudinal length L of the receiving holes 5e is set to be about twice as large as the diameter D of the shaft bodies 4a (L≈2D) so that the maximum amount P of movement becomes nearly equal to the diameter D of the shaft bodies 4a.

Preferably, the receiving holes 5e is sized so that the maximum amount P of movement of the clip body 5 is at least 0.2 times of the diameter D of the shaft bodies 4a. More preferably, the receiving holes 5e is so sized that the maximum amount P of movement of the clip body 5 is 0.5 times to 2 times of the diameter D of the shaft bodies 4a. Namely, in the case where the longitudinal axes of the receiving holes 5e are substantially perpendicular to the center axis L-L of the ballpoint pen body 1 as shown in FIGS. 2A to 2C, the longitudinal length L of the receiving holes 5e is set to be at least 1.2 times of the diameter D of the shaft bodies 4a (1.2D≦L) and, preferably, 1.5 times to 3 times (1.5D≦L≦3D).

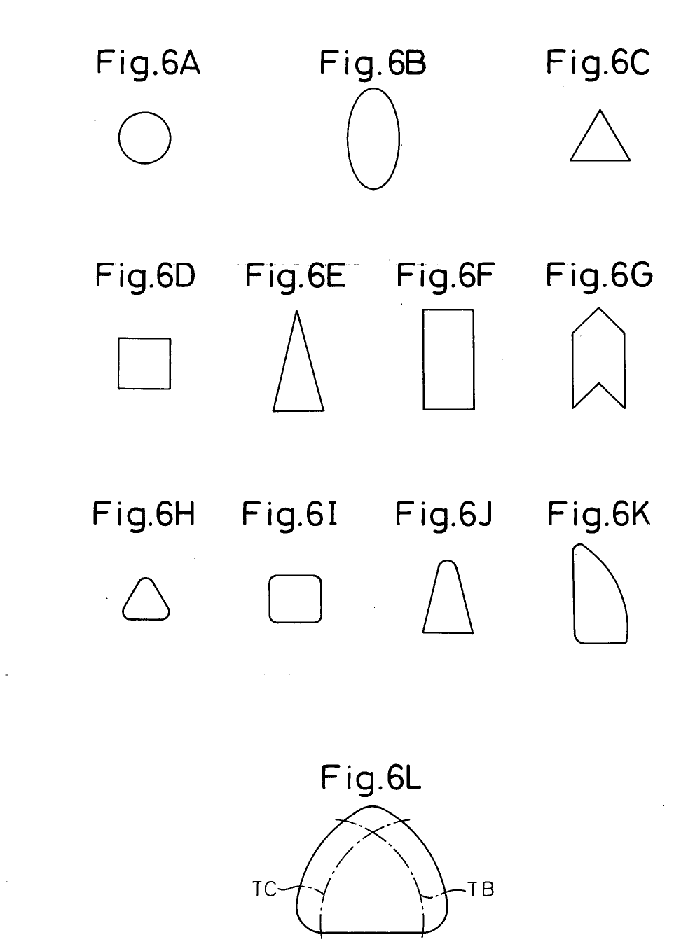

The receiving holes 5e may assume any shape so far as the clip body 5 is allowed to move relative to the ballpoint pen body 1. FIGS. 6A to 6L illustrate other embodiments of the receiving holes 5e. FIGS. 6C to 6G illustrate the cases where the receiving holes 5e are formed in polygonal shapes, and FIGS. 6H to 6K illustrate the cases where the receiving holes 5e are formed in polygonal shapes with at least one corner or side being rounded. In the above example of FIGS. 3A and 3B, the shaft bodies 4a move about the portion 9 where the article 8 and the clip body 5 are in contact. In the above example of FIGS. 4A and 4B, the shaft bodies 4a move about the portion 10 where the clip body 5 and the ballpoint pen body 1 are in contact. If the locus of the shaft bodies 4a in the former example is denoted by TB and that in the latter example by TC, FIG. 6L illustrates the case where the circumferential edges of the receiving holes 5e are formed along the above loci TB and TC. This assures smooth movement of the shaft bodies 4a or the clip body 5.

As described above, the clip body 5 is urged by the leaf spring 6 in a manner that the ball portion 5a abuts against the ballpoint pen body 1 and, at the same time, the shaft bodies 4a abut against the top edges 5ea of the receiving holes 5e. What is needed to obtain these two urging actions is to simply attach the front end 6b of the leaf spring 6 to the clip body 5 forward of the shaft bodies 4a. However, if the leaf spring 6 is lengthened and the front end 6b thereof is attached to the insertion hole 5f at the front end of the clip body 5 or around the ball portion 5a as in the embodiment of the present invention, a force to be applied to the operation portion 5b to open the clip 3 is reduced.

In the case where the leaf spring 6 is extended up to the front side of the shaft bodies 4a, the leaf spring 6 may interfere with or abut against the convex portion 4. Particularly, this tendency becomes conspicuous if the height of the shaft bodies 4a from the ballpoint pen body 1 is increased in order to increase the amount of movement of the clip body 5 relative to the ballpoint pen body 1. In the embodiment of the present invention, however, the dented groove 4b is formed in the convex portion 4, and thus the leaf spring 6 can be positioned in the dented groove 4b (see FIG. 2C). As a result, it is allowed to increase the amount of movement of the clip body 5 while preventing the leaf spring 6 from interfering with the convex portion 4. Accordingly, there is no need of providing a space for the leaf spring 6, and thus the clip 3 as a whole can be formed in a compact size. Upon forming the dented groove 4b, further, the convex portion 4 can be easily so deformed that the shaft bodies 4a approach each other when it is attempted to have the shaft bodies 4a received in the receiving holes 5e of the clip body 5, facilitating the attachment of the clip body 5. Furthermore, while being positioned in the dented groove 4b, the leaf spring 6 comes into engagement with the inner wall surfaces of the dented groove 4b contributing to enhancing stability of the clip body 5 in the transverse direction (direction of axis K-K, see FIG. 2C).

The clip body 5 does not have to be provided with the operation portion 5b as described above. However, provision of the operation portion 5b makes it easy to use it as a clip for the writing implement. Further, the clip according to the embodiment of the present invention can be easily and inexpensively produced since it includes a decreased number of parts and its mechanism is not complex.

According to the embodiment of the present invention described above, the spring 6 is constituted by a U-shaped single leaf spring opened toward the front side. Alternatively, the spring 6 may be, for example, a U-shaped single leaf spring opened toward the rear side. In this case, one end of the leaf spring is fixed in an insertion hole formed in the ballpoint pen body 1 rearward of the convex portion 4 and the other end of the leaf spring is fixed in the insertion hole formed in the clip body 5 around the operation body 5b.

### DESCRIPTION OF REFERENCE NUMERALS

1 . . . ballpoint pen body
3 . . . clip
4a . . . shaft bodies
5 . . . clip body
5e . . . receiving holes
6 . . . leaf spring

1. A clip for a writing implement, wherein the clip comprises a clip body, wherein one of a clip side-coupling portion formed on the clip body and an implement side-coupling portion formed on the outer surface of the body or cap of the writing implement, is constituted by a shaft body and the other is constituted by a receiving hole, wherein the shaft body is received in the receiving hole so as to swingably couple the clip body and the body or cap of the writing implement to each other, characterized in that the receiving hole is sized to be larger than the shaft body so that the clip body is able to move relative to the body or cap of the writing implement while being coupled to the body or cap of the writing implement and that the movement of the clip body relative to the body or cap of the writing implement is limited by abutment of the shaft body against a circumferential edge of the receiving hole, and that the clip comprises a spring for urging the clip body toward the body or cap of the writing implement.

2. The clip for a writing implement according to claim 1, wherein an operation portion is formed at a rear end of the clip body, wherein the spring is constituted by a leaf spring, and wherein an end of the leaf spring is attached to the implement side-coupling portion, or to the body or cap of the writing implement rearward of the implement side-coupling portion, and the other end of the leaf spring is attached to the clip body forward of the clip side-coupling portion.

3. The clip for a writing implement according to claim 2, wherein a dented groove opened facing the clip body is formed in the implement side-coupling portion so that the leaf spring is able to be positioned in the dented groove.

4. The clip for a writing implement according to claim 1, wherein the receiving hole is so sized that a maximum moving amount of the clip body relative to the body or cap of the writing implement is at least 0.2 times of the diameter of the shaft body.

5. The clip for a writing implement according to claim 4, wherein the receiving hole is so sized that a maximum moving amount of the clip body relative to the body or cap of the writing implement is 0.5 times to 2 times of the diameter of the shaft body.
